(19) United States
(12) Patent Application Publication
(10) Pub. No.: US 2005/0254070 A1
(43) Pub. Date: Nov. 17, 2005

(54) Image output apparatus

(76) Inventor: Katsumi Sayama, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/128,320

(22) Filed: May 13, 2005

(30) Foreign Application Priority Data
May 14, 2004 (JP) 2004-144374

(51) Int. Cl. B41B 1/00

(52) U.S. Cl. 358/1.1

(57) ABSTRACT

An image output apparatus is disclosed that includes a queued job access management part that authorizes access to a designated queued job for which access is requested by a queued job access request in a case where user identification information associated with the designated queued job that is stored in the queued job management part corresponds to the user identification information currently set as authorized apparatus user identification information by an authorized apparatus user authentication part, and a queued job access executing part that conducts predetermined access control with respect to the designated queued job for which access is authorized by the queued job access management part.

### BACKGROUND OF THE INVENTION

1. Field of the Invention

The present invention generally relates to an image output apparatus that may be applied to a facsimile machine, a copier, or a multifunction printer, for example. The present invention particularly relates to an image output apparatus that is configured to input image data and attached information thereof as a job, temporarily store the input job as a queued job, and conduct a predetermined image output process for the image data when a predetermined process starting condition is satisfied.

2. Description of the Related Art

An imaging apparatus such as a facsimile machine, a copier, or a multifunction printer that includes an image output apparatus is configured to conduct a predetermined image output process on input image data. The input image data may correspond to image data input by an image reading unit of the imaging apparatus, or image data input from another apparatus such as a personal computer (PC) via image input means such as a network interface, for example. The image output process may correspond to transmitting the image data to a destination apparatus that is designated by destination identification information (e.g., facsimile number, mail address, IP address) that is specified or input as attached information of the input image data, or outputting the image data on recording paper using an image recording unit provided within the imaging apparatus, for example.

An image output apparatus as is described above stores various types of information including identification information such as a file number for identifying image data that are input and stored in the image output apparatus, and information pertaining to the number of copies or the transmission time, for example, as attached information, and manages the input/stored image data and attached information thereof as a job.

An input job (image data and attached information thereof) is temporarily stored and retained as a queued job, and a predetermined output process is conducted for the queued job when a predetermined process starting condition is satisfied.

For example, in the case of printing the image data onto recording paper by means of an image recording unit provided within the imaging apparatus, the predetermined process starting condition may be satisfied when the image recording unit is in a usable state (e.g., the image recording unit has completed an output process for image data associated with another job, or has completed a warm-up process). In a case of conducting facsimile transmission or network transmission by means of a communication unit provided within the imaging apparatus, the predetermined process starting condition may be satisfied when the a designated transmission time is reached, or when the communication unit is in a usable state (e.g., the communication unit has completed an output process for image data associated with another job).

An image output apparatus that manages and processes a queued job as is described above is further arranged to be capable of conducting various accessing operations including canceling an output process specifying a queued job (e.g., identification information such as a file number) that is to be stored and retained until an output process it conducted thereon by the image output apparatus (job cancellation), changing the attached information such as the transmission time or the number of copies specifying the queued job, and referencing (seeing) the image data and/or attached information specifying the queued job, for example. In this way, flexibility is provided with respect to a queued job for which an output process is not yet completed.

However, it is noted that a user inputting a job may not wish to allow other users to access (see) certain information associated with the queued job such as the image data itself of or certain types of attached information such as transmission destination identification information (e.g., a facsimile number, a main address, or an IP address). Also, it is noted that problems may be created when attached information of a queued job is changed by another user without the knowledge of the user initially inputting the job, or when a corresponding output process for a job is cancelled by another user without the knowledge of the user initially inputting the job.

It is noted that Japanese Laid-Open Patent Publication No. 2003-189036 discloses a background art relating to the present invention. However, the above document merely discloses a technique for controlling accessible information of management information associated with a queued job according to an identified confirmer.

In the prior art, it has been possible for a user other than the user inputting a job to conduct accessing operations such as referencing, canceling, and changing information associated with the queued job being stored and retained in the image output apparatus, and thereby, confidentiality cannot be sufficiently ensured with respect to information included in the queued job (image data and attached information thereof).

### SUMMARY OF THE INVENTION

The present invention has been conceived in response one or more of the problems of the related art, and its object is to provide an image output apparatus that is able to ensure confidentiality when a queued job is accessed for referencing, canceling, or changing information associated with the queued job, for example.

According to an aspect of the present invention, an image output apparatus is provided that is configured to input image data and attached information thereof as a job, temporarily store the input job as a queued job, and output the image data of the queued job in a predetermined format when a predetermined process starting condition is satisfied, the apparatus including:
an authorized apparatus user authentication part that determines whether a user corresponds to an authorized apparatus user through a predetermined authentication process before the user conducts a job input operation, and upon determining that the user corresponds to the authorized apparatus user, sets user identification information associated with the user as authorized apparatus user identification information;
a queued job management part that stores a job input after authentication by the authorized apparatus user authentication part as a queued job associated with user information that is currently set as the authorized apparatus user identification information by the authorized apparatus user authentication part;
a queued job access management part that authorizes access to a designated queued job for which access is requested by a queued job access request in a case where user identification information associated with the designated queued job that is stored in the queued job management part corresponds to the user identification information currently set as the authorized apparatus user identification information by the authorized apparatus user authentication part; and
a queued job access executing part that conducts predetermined access control with respect to the designated queued job for which access is authorized by the queued job access management part.

In a preferred embodiment of the present invention, the predetermined access control conducted by the queued job access executing part includes controlling referencing of the designated queued job.

In another preferred embodiment of the present invention, the predetermined access control conducted by the queued job access executing part includes controlling changing of the attached information of the designated queued job.

In another preferred embodiment of the present invention, the predetermined access control conducted by the queued job access executing part includes controlling canceling of the designated queued job.

In another preferred embodiment of the present invention, when the user identification information associated with the designated queued job that is stored in the queued job management part does not correspond to the user identification information currently set as the authorized apparatus user identification information by the authorized apparatus user authentication part, the queued job access management part is arranged to authorize access to the designated queued job in a case where a user identified by the user identification information associated with the designated queued job that is stored in the queued job management part is authorized to conduct an interrupt queued job access operation through a predetermined interrupt queued job access authentication process.

In another preferred embodiment of the present invention, when the user identification information associated with the designated queued job that is stored in the queued job management part does not correspond to the user identification information currently set as the authorized apparatus user identification information by the authorized apparatus user authentication part, the queued job access management part is arranged to authorize access to the designated queued job for a user that is authenticated as an administrator through a predetermined administrator authentication process.

In another preferred embodiment, the image output apparatus of the present invention further includes a queued job access authorized user setting part that stores user identification information identifying a user authorized to access the designated queued job in association with the queued job input after authentication by the authorized apparatus user authentication part and stored in the queued job management part.

In another preferred embodiment of the present invention, when the user identification information associated with the designated queued job that is stored in the queued job management part does not correspond to the user identification information currently set as the authorized apparatus user identification information by the authorized apparatus user authentication part, the queued job access management part is arranged to authorize access to the designated queued job in a case where a user identified by user identification information associated with the designated queued job that is stored in the queued job access authorized user setting part is authorized to access the designated queued job through a predetermined access authorized user authentication process.

### BRIEF DESCRIPTION OF THE DRAWINGS

FIG. 1 is a block diagram showing a configuration of a communication system including a multifunction printer as an image output apparatus according to an embodiment of the present invention;

FIG. 2 is a block diagram showing an exemplary configuration of a multifunction printer as an image output apparatus according to an embodiment of the present invention;

FIG. 3 is a diagram illustrating storage contents of an EEPROM of the multifunction printer of FIG. 2;

FIG. 4 is a diagram illustrating storage contents of a RAM of the multifunction printer of FIG. 2;

FIG. 5 is a table illustrating storage contents stored in a queued job management table;

FIG. 6 is a flowchart illustrating process steps of job input related operations conducted in the multifunction printer of FIG. 2;

FIG. 7 is a flowchart illustrating process steps of an authorized user authentication process;

FIG. 8 is a flowchart illustrating process steps of a queued job processing operation conducted in the multifunction printer of FIG. 2;

FIG. 9 is a flowchart illustrating process steps of a queued job access authorized user setting process;

FIG. 10 is a flowchart illustrating process steps of a queued job access management process;

FIG. 11 is a flowchart illustrating process steps of an administrator authentication process;

FIG. 12 is a flowchart illustrating process steps of an interrupt queued job access authentication process; and

FIG. 13 is a flowchart illustrating process steps of a queued job access execution process.

### DESCRIPTION OF THE PREFERRED EMBODIMENTS

In the following, preferred embodiments of the present invention are described with reference to the accompanying drawings.

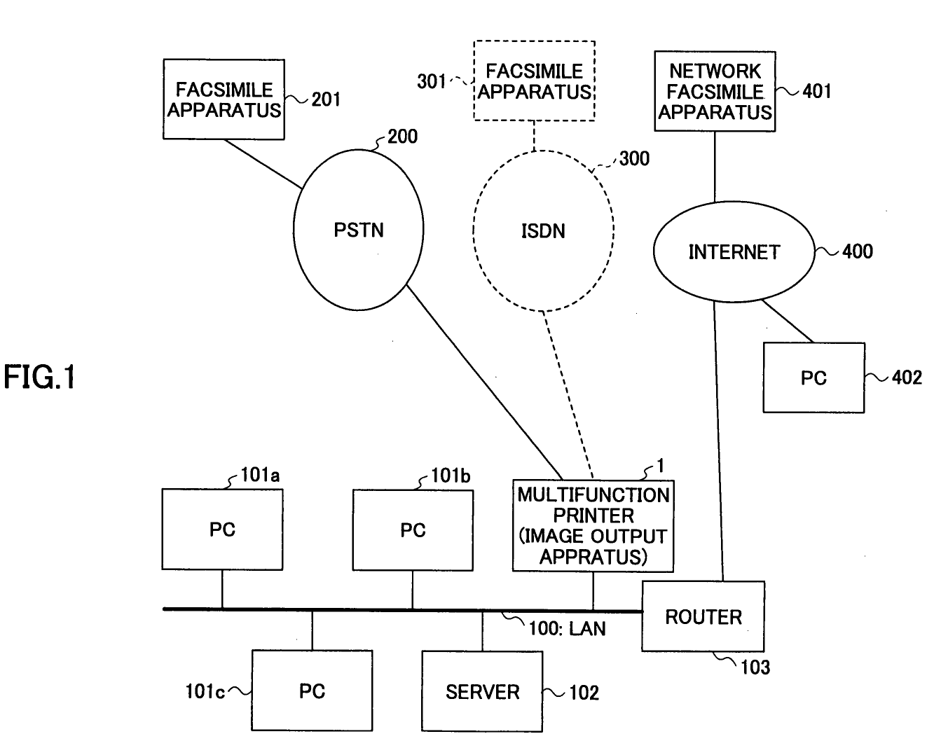

FIG. 1 is a block diagram showing a configuration of a communication system including a multifunction printer 1 as an image output apparatus according to an embodiment of the present invention.

The multifunction printer 1 of FIG. 1 is configured to realize multiple functions such as a network interface function, a communication function, a document reading function, an image printing function, and an image transmission function, for example. As is shown in this drawing, the multifunction printer 1 is connected to a PSTN (Public Switched Telephone Network) 200 to transmit image data to a facsimile apparatus 201 corresponding to a G3 facsimile apparatus that is connected to the PSTN 200, for example.

It is noted that in the following descriptions, image data may refer to any form of data that may eventually be output as an image. For example, image data may correspond to data to be printed on a recording medium such as recording paper, or data to be displayed on a display unit. It is noted that image data may include data of a bit map image that are obtained by reading a document, text data made up of a character code sequence that are converted into image data based on font data upon printing or display of the data, encoded image data, and file data in a predetermined format that are created by a document creating application such as word processor software, for example. In other words, data referred to as image data in the following descriptions are not limited to image data in their input/output formats.

It is noted that the multifunction printer 1 may also be configured to transmit image data to a facsimile apparatus 301 corresponding to a G4 facsimile apparatus connected to an ISDN (Integrated Services Digital Network) 300 given that the multifunction printer is provided with required interface and protocol functions for realizing such a transmission.

Also, the multifunction printer 1 is connected to a LAN 100, and is configured to conduct a predetermined transmission process such as network transmission or e-mail transmission of image data with respect to a network facsimile apparatus 401 or a personal computer 402 that are connected to the Internet 400 via a router 103.

Also, the multifunction printer 1 is connected to personal computers (PC) 101a, 101b, and 101c via the LAN 100. The LAN 100 is connected to a server 102, which corresponds to an information processing apparatus for providing an IP address corresponding to a host name using the DNS (Domain Name System), providing mail transmission service using the SMTP, and providing mail receiving service using the POP3, for example.

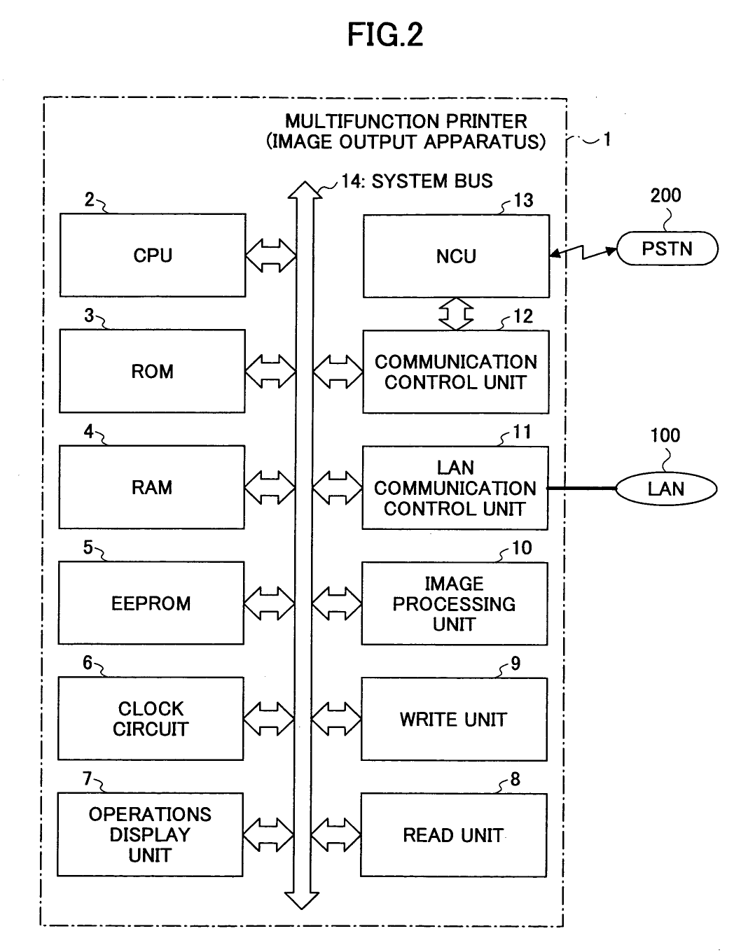

FIG. 2 is a block diagram showing a configuration of the multifunction printer 1 as an image output apparatus according to an embodiment of the present invention.

According to FIG. 2, the multifunction printer 1 includes a CPU 2, a ROM 3, a RAM 4, a EEPROM 5, a clock circuit 6, an operations display unit 7, a read unit 8, a write unit 9, an image processing unit 10, a LAN communication control unit 11, a communication control unit 12, a NCU (Network Control Unit) 13, and a system bus interconnecting these units.

The CPU 2 is configured to control the respective units of the multifunction printer 1, perform various data processes, and conduct protocol control based on control programs and data written in the ROM 3 using the RAM 4 as a working area.

The ROM 3 stores control programs for enabling the CPU 2 to control the respective units of the multifunction printer 1, and various types of data for controlling data such as font data corresponding to character codes.

The RAM 4 is used by the CPU 2 as a working area as is described above.

The EEPROM (Electronically Erasable and Programmable Read Only Memory) 5 stores various forms of information for realizing operations of the apparatus, and is configured to retain its stored contents even when the power of the apparatus is turned off. It is noted that the EEPROM 5 may be replaced by a battery-backed SRAM (Static RAM) or a magnetic disk apparatus.

The clock circuit 6 is arranged to keep track of the current time and date, and the CPU 2 may access the clock circuit 6 via the system bus 14 to determine the current time and date.

The operations display unit 7 includes keys for accepting various operation inputs from a user, and a display a liquid crystal display for indicating information to be conveyed to the user such as the operation state of the apparatus and various types of messages.

The read unit 8 is configured to read a document that is set to the apparatus and input the read document image data.

The write unit 9 is configured to print image data on recording paper.

The image processing unit 10 is configured to conduct various image processes on image data being handled in the image output apparatus (multifunction printer) 1, including encoding/decoding processes involving compressing raw image data and decompressing compressed data, a binarization process, a scaling process, expanding/contracting processes, an image correction process, and an appending process for appending additional information such as character sequence information of the transmission date/time or the reception time/date, for example.

The LAN communication control unit 11 corresponds to a so-called NIC (Network Interface Card), and is connected to the LAN 100 corresponding to an Ethernet LAN, for example. The LAN communication control unit 11 is configured to realize TCP/IP protocol communication on the Ethernet protocol to enable information exchange based on various upper-layer protocols such as the HTTP, the SMTP, and the POP, for example.

The communication control unit 12 is connected to the PSTN 200 via the NCU 13. Specifically, the communication control unit 12 is connected to a subscriber phone line network/private network to control communication with a counterpart communication terminal. The communication control unit 12 controls the NCU 13 to detect a pulse of a ringing voltage, a DTMF signal, or a tone signal, or to call out the transmission time, for example. Also, the communication control unit 12 includes a modem for demodulating modulated data received from a communication counterpart terminal, or modulating transmission data for transmission to the communication counterpart terminal. Specifically, the communication control unit 12 includes a low-speed modem functionality for exchanging G3 facsimile control signals based on the ITU-T T.30 Recommendation (V.21 modem), and V.17, V.33, V.34, V.29, and V.27ter modems corresponding to high-speed modem functionalities for exchanging document image data.

The NCU 13 is connected to the PSTN 200 and is configured to close a network, and detect signals such as a call signal (ringing), for example.

The system bus 14 corresponds to a signal line including a data bus, an address bus, a control bus, and an interrupting signal line, for example, and is configured to enable data exchange between the respective units of the image output apparatus 1.

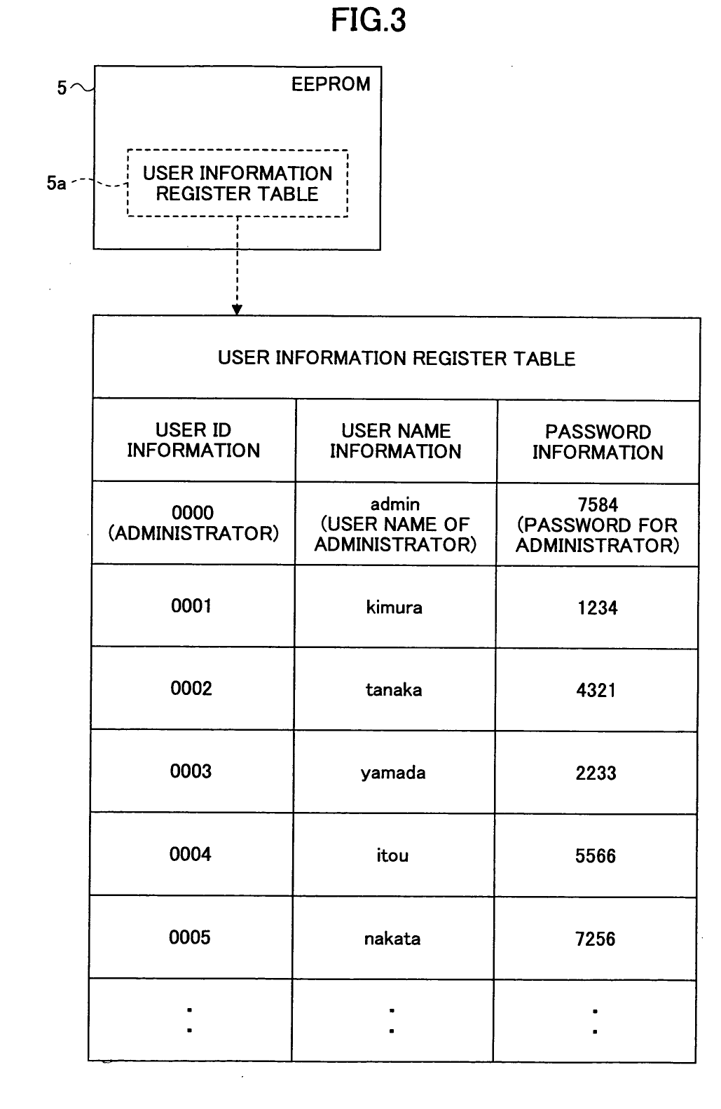

FIG. 3 is a table representing storage contents of the EEPROM 5 of the multifunction printer 1 of FIG. 2.

In FIG. 3, the EEEPROM 5 includes a storage area for storing a user information register table 5a.

The user information register table 5a stores information for authenticating a user. Specifically, the user information register table 5a includes a ‘user identification information’ field, a ‘user name information’ field, and a ‘password information’ field that are associated with each other.

The user identification information corresponds to a 4-digit number from ‘0000’ to ‘9999’. It is noted that in the user information register table 5a the user identification information ‘0000’ is assigned to a special user, namely, an administrator, and user name information ‘admin’ is registered as corresponding user name information. Also, a number ‘7584’ is registered as corresponding password information. The user identification information ‘0001’ through ‘9999’ are assigned to general users other than the administrator.

According to the present example, a user that inputs ‘admin’ as the user identification information and the number ‘7584’ as the password information may be authenticated as the user identified by the user identification information ‘0000’ (i.e., the administrator).

It is noted that users other than the administrator may be authenticated in a similar manner. That is, a user may be authenticated as a user identified by corresponding user identification information when the user is able to accurately input the password information corresponding to the input user name information of the user.

In the present example, a user that is registered in the user information register table 5a may be authorized to use the multifunction printer 1 upon being authenticated through a predetermined authentication process. On the other hand, a user that is not registered in the user information register table 5a may not be authorized to use the multifunction apparatus 1. That is, an unregistered user may not use the image output functions of the multifunction printer 1.

A combination of user name information and password information assigned for each user identification information ‘0001’ through ‘9999’ is authenticated by the administrator (corresponding to user identified by user identification information ‘0000’) to be registered in the user information register table 5a. The administrator informs the corresponding user identified by the given user identification information of the registered combination of the user name information and the password information while taking precautionary measures to prevent other persons from acquiring knowledge of the combination information.

It is noted that the present invention is not limited by a particular user authentication process. For example, a conventional authentication process may be implemented in which a combination of user name information (user ID) and password information (password) is input to determine a corresponding user (user identification information). Other examples include reading a magnetic card or an IC card, for example, that stores unique information for a user to determine the corresponding user (user identification information); or matching a pre-registered fingerprint pattern of a user (or some other unique physical feature of the user) with a fingerprint pattern (or physical feature) of a user currently being read to determine the corresponding user (user identification information).

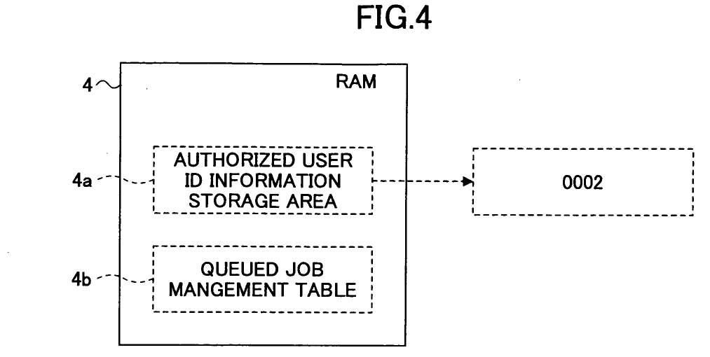

FIG. 4 is a diagram illustrating the storage contents of the RAM 4 included in the multifunction printer 1 of FIG. 2.

According to FIG. 4, the RAM 4 includes an authorized user identification information storage area 4a and a queued job management table 4b. The authorized user identification information storage area 4a stores user identification information of a user that is authenticated as a user authorized to use the multifunction printer 1 out of the users (user identification information) registered in the user information register table 5a. In the example of FIG. 4, the user corresponding to the user identification information ‘0002’ is indicated as the user authorized to use the multifunction printer 1.

A currently authorized (authenticated) user (i.e., user identified by the user identification information that is set in the authorized user identification information storage area 4a) may use the image output functions of the multifunction printer 1.

It is noted that the setting of the authorized user identification information is cleared relatively quickly after the authorized user completes operations on the multifunction printer 1. Once the setting of the authorized user identification information is cleared, a user has to be authenticated once more in order to be authorized to use the multifunction printer 1.

The authorization time period during which a user may be authorized to use the multifunction printer 1 may be arranged to last until a detection is made by a sensor that the authorized user has moved away from the multifunction printer 1, for example. In another example, the authorization time period may last until the authorized user conducts an explicit authentication (authorization) clearance operation or until a predetermined time period elapses from the time of authentication. Also, in a case where authentication is conducted based on a magnetic card or an IC card, for example, the authorization time period may be set to last until the inserted card is pulled out. It is noted that the present invention is not limited to the specific examples described above, and authorization for using the image output apparatus may be cleared in any manner.

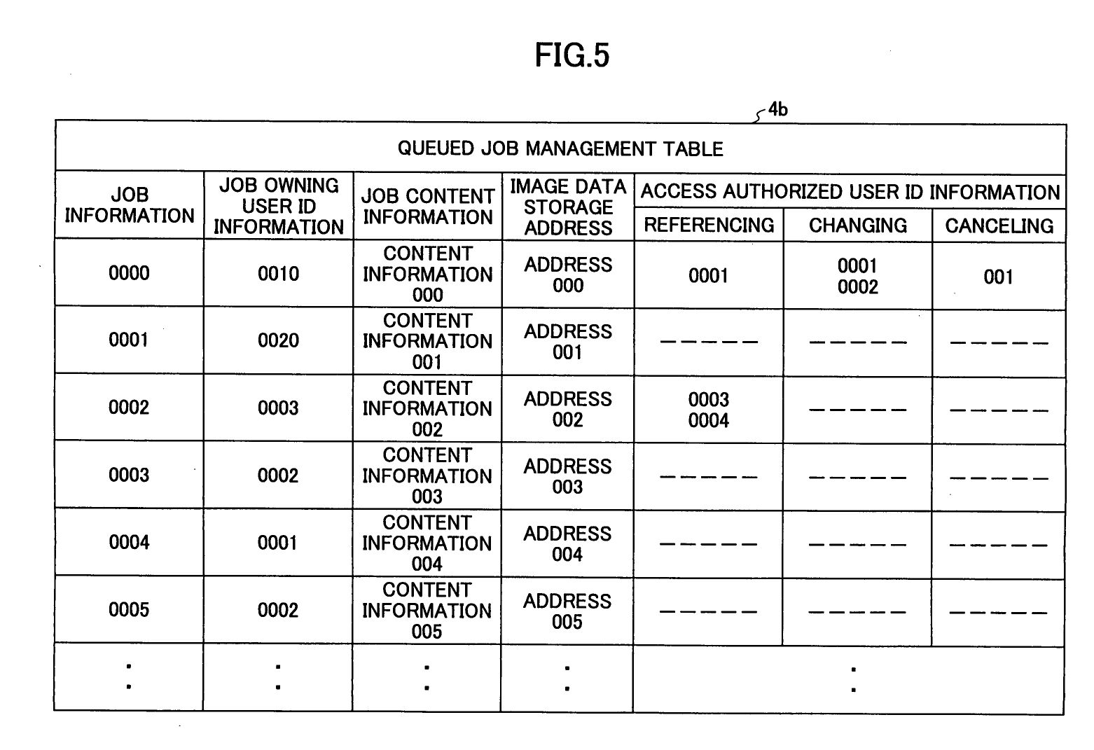

FIG. 5 is a table illustrating storage contents of the queued job management table 4b.

According to FIG. 5, the queued job management table 4b includes fields describing ‘job identification information’ corresponding to a 4-digit number from ‘0000’ through ‘9999’, ‘job owning user identification information’, ‘job content information’ corresponding to attached information, ‘image data storage address’, and ‘access authorized user identification information’, respectively.

The ‘job owning user identification information’ describes information pertaining to the user that has input the job identified by the corresponding ‘job identification information’ in the queued management table 4b, and corresponds to one of the ‘user identification information’ entries registered in the user information register table 5a of FIG. 3. According to a preferred embodiment, basically, a user is only allowed to conduct access operations such as referencing, changing, and canceling for a job that he/she has input (assigned).

The ‘job content information’ describes information that is input as attached information along with image data associated with a job. For example, the ‘job content information’ may describe various types of information including the transmission output start time, a facsimile number as the transmission destination, an e-mail address, and/or a number of copies designated by the job.

The ‘image data storage address’ describes the storage address within the RAM 5 of the image data associated with a job.

The ‘access authorized user identification information’ describes information pertaining to users other than the user identified by the corresponding ‘job owning user identification information’ that are allowed to access the job identified by the corresponding ‘job identification information’.

In the illustrated example, the ‘access authorized user identification information’ registers information on users authorized to conduct three types of job accessing operations, namely, ‘referencing’, ‘changing’ and ‘canceling’, respectively. It is noted that entries represented by ‘- - - - ’ indicate that no other user is registered as a user authorized to conduct the corresponding accessing operation. The information registered as access authorized user identification information corresponds to one or more of the ‘user identification information’ entries registered in the user information register table 5a of FIG. 3.

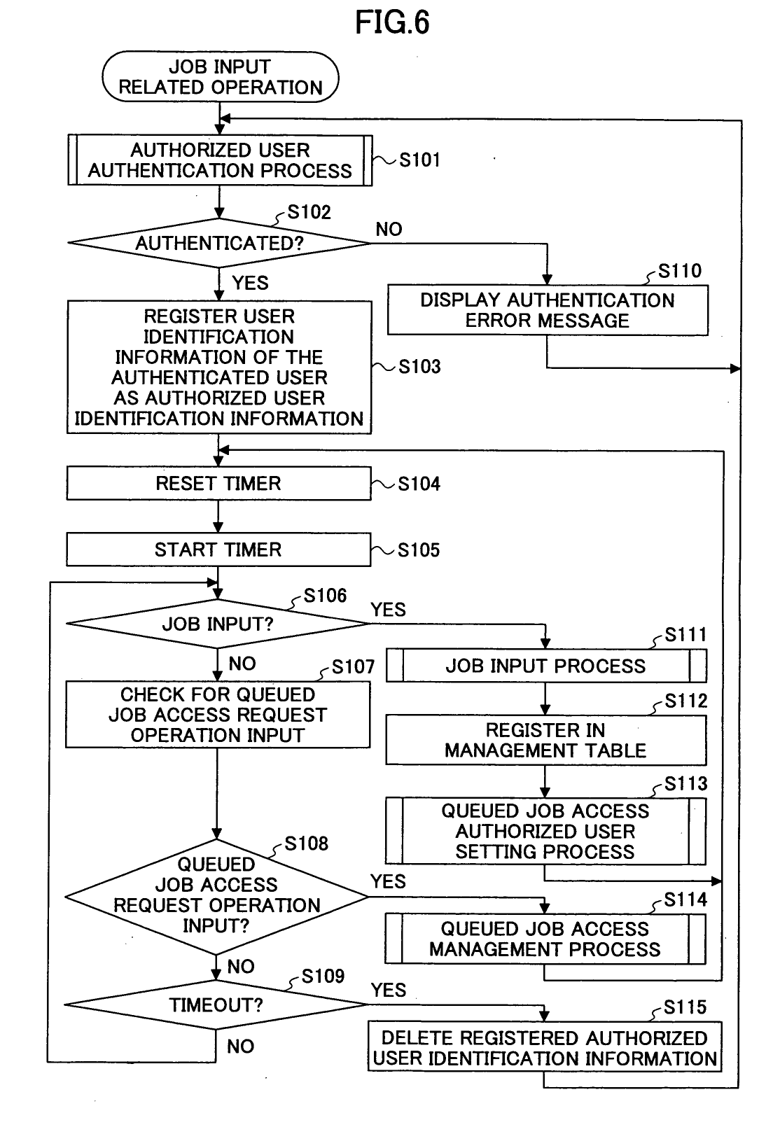

FIG. 6 is a flowchart illustrating process steps relating to a job input operation conducted at the multifunction printer 1 described above. It is noted that in the present example, step S101 is realized by an authorized apparatus user authentication part, steps S111 and S112 are realized by a queued job management part, step S113 is realized by a queued job access authorized user setting part, and step S114 is realized by a queued job access management part.

In FIG. 6, the multifunction printer 1 may be used only under certain conditions; that is, a user may not use the multifunction printer 1 unless he/she is registered as an authorized user of the multifunction printer 1 and is properly authenticated. Accordingly, in a job input operation, first, the apparatus usage authentication process (S101) is conducted.

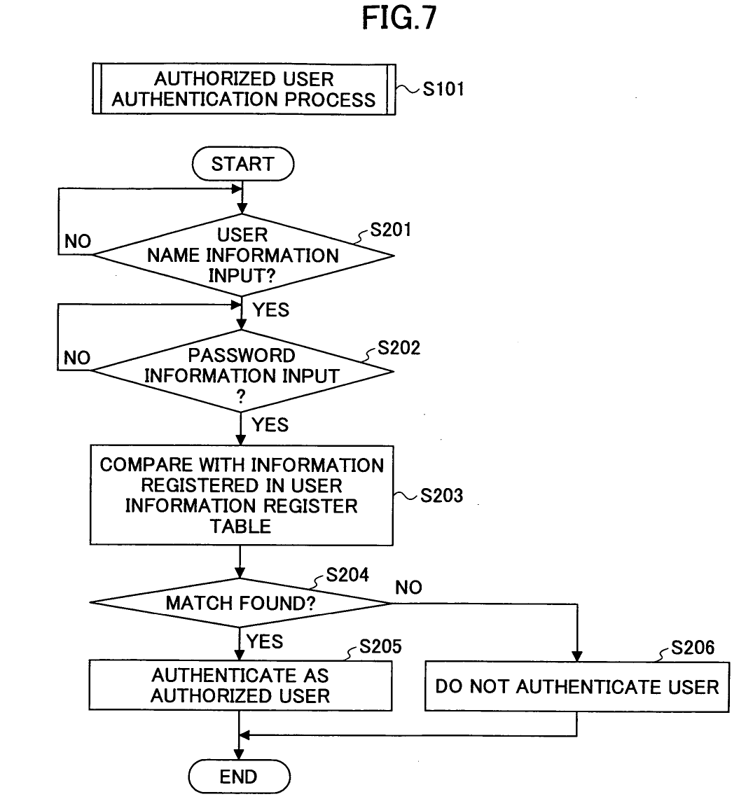

FIG. 7 is a flowchart illustrating process steps of the apparatus usage authentication process of S101.

According to FIG. 7, first, monitoring is conducted to determine whether user name information is input (i.e., a user name information input determination step S201 is repetitively conducted until an input is detected). Since the user is informed of his/her corresponding ‘user name information’ and ‘pass word information’ by the administrator, the user may input his/her corresponding ‘user name information’. For example, if the user corresponds to a user identified by the user identification information ‘0001’, the user may input ‘kimura’ as the ‘user name information’.

After a user name information input is detected (S201, Yes), monitoring is conducted to determine whether password information is input (i.e., a password information input determination step S202 is repeated until an input is detected). For example, if the user corresponds to the user identified by the user identification information ‘0001’ in the user information register table 5a of FIG. 3, the user may input ‘1234’ as the password information.

After a password information input is detected (determination step S202, Yes), the user identification information input detected in the determination step S201 and the password information input detected in step S202 are compared with the registered contents of the user information register table 5a of FIG. 3 (step S203). When an entry registering the detected ‘user identification information’ and ‘password information’ as a pair is found in the user information register table 5a (S204, Yes), the user identified by the corresponding ‘user identification information’ of the entry is authenticated as an authorized user of the multifunction printer 1 (S205). On the other hand, in a case where an entry registering the detected ‘user identification information’ and ‘password information’ as a pair is not found in the user information register table 5a (S204, No), the user inputting the ‘user identification information’ and ‘password information’ is not authenticated as an authorized user of the multifunction printer (S206).

Referring back to FIG. 6, in step S102, a determination is made as to whether the user conducting the job input operation is authenticated in the apparatus usage authentication process of step S101. If the user is not authenticated (S102, No), an authentication error message such as that indicating, ‘You are unauthorized to use this apparatus’ or ‘An incorrect password has been input’, is displayed on the operations display unit 7, and the operation goes back to the process step S101.

If the user is authenticated in step S102 (S102, Yes), the corresponding user identification information of the authenticated information is registered in the authorized user identification information storage area 4a of FIG. 4 (S103).

Then, a timer with a time constant of 30 seconds, for example, is reset (S104), and the timer is started (S105). It is noted that the timer is provided to control the time period (i.e., 30 seconds in this example) during which a user currently authenticated as an authorized user (i.e., user corresponding to the authorized user identification information currently registered in the storage area 4a of FIG. 4) is able to use the multifunction apparatus 1.

After the timer is started in step S105, a determination is made as to whether a job input is made (S106). If a job input is not made (S106, No), a determination is made as to whether a queued job access' request operation input is made (S107). If such a request operation input is not made (S108, No), a determination is made as to whether the timer started in step S105 has already reached its time limit (S109). If the time limit is not yet reached (S109, No), the operation goes back to step S106.

In the determination step S109, if it is determined that the timer has reached the time limit (S19, Yes), the authorized user identification information registered in the storage area 4a of FIG. 4 in step S103 is deleted (S115), and the operation goes back to step S101.

In the determination step S108, if it is determined that a ‘queued job access’ request operation input is made (S108, Yes), the queued job access management process S114 is conducted. Then, the operation goes back to step S101.

In the determination step S106, if it is determined that a job input has been made (S106, Yes), a job input process is conducted (S111), and the input job is registered in the queued job management table 4b of FIG. 5 (S112). Also, a queued job access authorized user setting process is conducted (S113) on the input job. Then, the operation goes back to step S101.

The job input process step S111 corresponds to a process of reading a document that is set to the read unit 8 and storing the read document image data in the RAM 4 when a copying process start command is input via the operations display unit 7, a facsimile transmission process start command is input via the PSTN 200, or a network facsimile transmission command is input via the Internet 400, for example.

In this case, transmission destination identification information such as a number of copies, a destination facsimile number, a destination e-mail address, and/or a destination IP address may be input as attached information of the input image data.

The process step S112 corresponds to a process of associating the image data (storage address thereof) and attached information thereof (job content information) input in step S111 with ‘job identification information’ that is open, and registering the associated information set in the queued job management table 4b of FIG. 5. Also, the ‘authorized user identification information’ currently registered in the storage area 4a of FIG. 4 is registered as ‘job owning user identification information’ in the queued job management table 4b. In other words, a job input by a user authorized to use the multifunction printer 1 is owned by this user.

A job that is input and stored in the multifunction printer 1 is stored and retained as a queued job until processing relating to the job is completed.

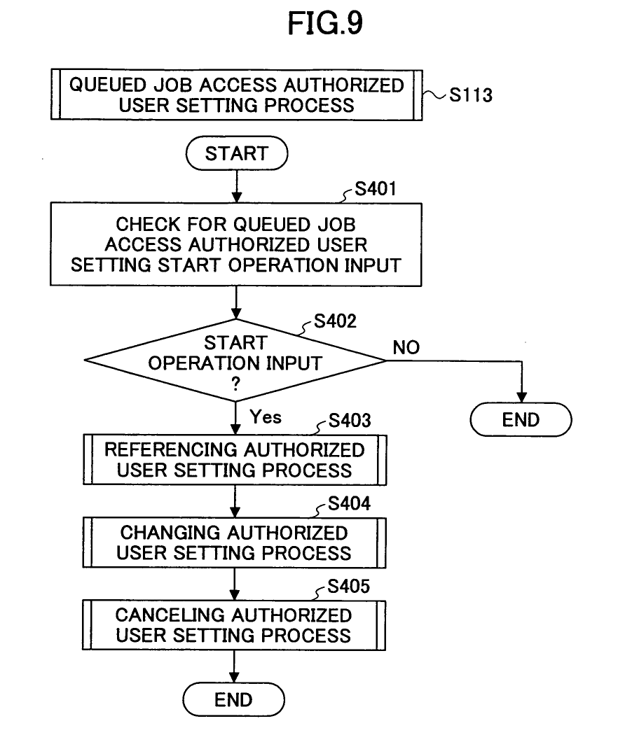

The process step S113 corresponds to a process of setting a user other than the user identified by the corresponding ‘job owning user identification information’ associated with a queued job that may be authorized to access the queued job in a given case where a job is input in step S111 and registered and retained in step S112. It is noted that in FIG. 9 specific process steps of the queued job access authorized user setting process step S113 are shown.

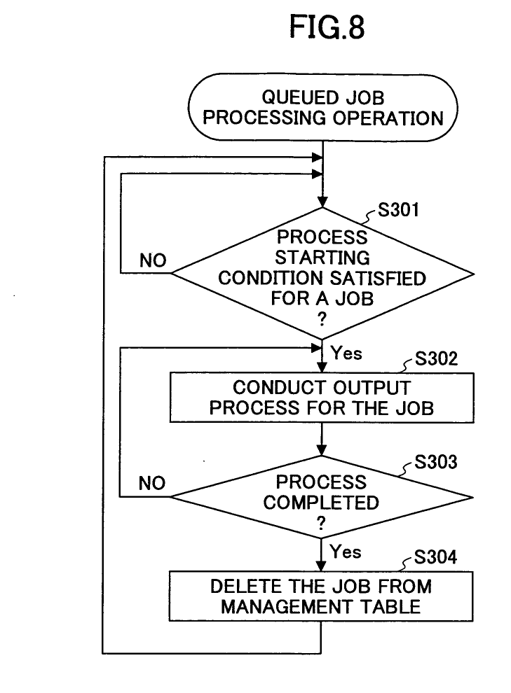

FIG. 8 is a flowchart illustrating process steps for processing a job that is input in step S111 and is registered as a queued job in step S112.

According to FIG. 8, first, a determination is made as to whether a process starting condition is satisfied for a queued job identified by ‘job identification information’ that is registered in the queued job management table 4b of FIG. 5 (S301). If there is no queued job for which a process starting condition is satisfied (S301, No), the determination step S301 is repetitively conducted.

When a queued job for which a process starting condition is satisfied is found (S301, Yes), the process moves on to step S302.

In a case where a queued job corresponds to a printing job pertaining to copying, for example, a process starting condition for the queued job may be satisfied when the power of the write unit 9 is turned on, set to an image recording operation mode, switched from a power saving mode to an image recording operation mode, or is prepared to process a next queued job after having completed an image recording operation of another copying job. If the write unit is already set to the image recording operation mode, the process starting condition may be immediately satisfied. In a case where the queued job corresponds to a job pertaining to facsimile transmission or transmission via a network, for example, the process starting condition may be satisfied when the communication control unit 12 is set to be able to conduct transmission by completing a process of receiving a facsimile transmission (i.e. switched from a used state to an unused state), when the transmission time is reached, or when the access interval to a mail server is reached in the case of conducting transmission via e-mail.

In the process step S302, image data (identified by ‘image data storage address’ of queued job management table 4b of FIG. 5) associated with a job (identified by the ‘job identification information’ of the queued job management table 4b of FIG. 5) for which a process starting condition is determined to be satisfied in step S301 are output according to the corresponding ‘job content information’. For example, a certain number of copies may be recorded by the write unit according to the designated number of copies, or transmission may be conducted at the designated transmission time via the communication control unit 12 or the LAN communication control unit 11. In step S303, a determination is made as to whether the output process is completed, and when the output process is completed (S303, Yes), the corresponding job (identified by the ‘job identification information’) is deleted from the queued job management table 4b of FIG. 5 (S304), and the operation goes back to step S301. It is noted that the deletion step S304 includes deleting the respective field information for the corresponding job registered in the queued job management table 4b of FIG. 5 as well as the image date stored in the ‘image data storage address’.

It is noted that the corresponding entry identified by the ‘job identification information’ of the queued job management table 4b of FIG. 5 deleted in step S304 becomes an empty entry that may be used to register another different job that is input later.

Also, it is noted that in the present embodiment, an input job is not processed until it is determined in step S301 that a corresponding process starting condition has been satisfied. That is, the job is temporarily registered and retained in the multifunction printer 1 as a queued job although the queue time for the job may vary depending on each case.

FIG. 9 is a flowchart illustrating process steps for setting and registering a user other than a user owning a queued job that may be authorized to access the queued job. It is noted that the queued job access authorized user setting process of FIG. 9 (corresponding to process step S113 of FIG. 6) is conducted when a job is input (S111) and registered (S112).

According to FIG. 9, first, monitoring is conducted for detecting a predetermined operation input for starting the ‘queued job access authorized user setting’ that may be made via the operations input unit 7 (S401). In a case where it is determined that such an input has not been detected (S402, No), this signifies that the user owning the input job (currently authenticated user) does not wish to allow other users to access the corresponding queued job, and thereby, the operation is ended.

In the determination step S402, if it is determined that an operation for starting such a setting process has been input (S402, Yes), a referencing authorized user setting process S403, a changing authorized user setting process S404, and a canceling authorized user setting process S405 are conducted in the registering step S112 of FIG. 6.

The referencing authorized user setting process S403 corresponds to a process of registering in the item ‘referencing’ (access type) of the field ‘access authorized user identification information’ the desired ‘user identification information’ of the registered ‘user identification information’ stored in the user information register table 5a of FIG. 3. Such a process may be conducted through interactive operation via the operations display unit 7, for example. Specifically, desired ‘user name information’, which is disclosed among authorized users, for example, may be input, and the corresponding ‘user identification information’ of the input ‘user name information’ that is registered in the user information register table 5a is registered in the field item ‘referencing’ of the queued job management table 4b. In another example, the ‘user identification information’ may be directly input. However, it is noted that it may be easier and more convenient for a user to be able to input the ‘user name information’ since such information may be more identifiable with the corresponding user. Also, in a case where there is no other user subject to ‘referencing’ authorization, no ‘user identification information’ is registered in the filed item ‘referencing’ (i.e., the corresponding entry may be left as ‘- - - - ’).

It is noted that similar interactive operations may be conducted for the changing authorized user setting process S404 and the canceling authorized user setting process S405.

In this way, a user owning a queued job may be able to set other users authorized to access the queued job for each individual type of accessing operation.

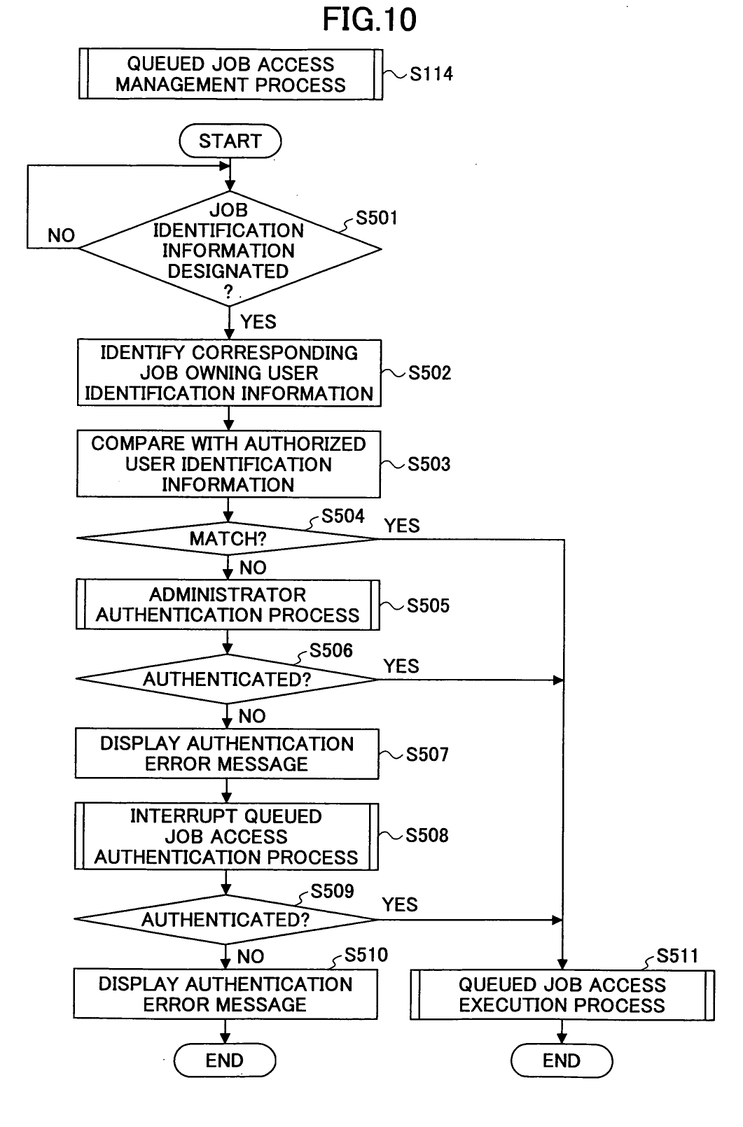

FIG. 10 is a flowchart illustrating process steps for conducting the queued job access management process S114 of FIG. 6. It is noted that in the present example, a queued job access execution process step S511 of FIG. 10 is realized by a queued job access execution part.

In FIG. 10, first, monitoring is conducted to determine whether specific ‘job identification information’ is designated via the operations display unit 7 by a user wishing to access (e.g., reference, change, or cancel) the corresponding queued job (S501). It is noted that such a user corresponds to the user conducting a ‘queued job access’ request operation input operation in the process step S107 of FIG. 6. Upon designating the ‘job identification information’, a list of the ‘job identification information’ and the ‘job owning user identification information’ registered in the queued job management table 4a of FIG. 5, and the corresponding ‘user name information’ stored in the user information register table 5a of FIG. 3 may be displayed in the operations display unit 7. In this way, a user may be able to identify the job that he/she has input. In another example, the ‘job identification information’ registered in association with an input job may be displayed at the operations display unit 7 at the time a user makes the job input so that the user may be informed of the corresponding ‘user identification information’ for his/her input job. In another example, when a user inputs his/her ‘user name information’, a list of ‘job identification information’ associated with the corresponding ‘user identification information’ for the input ‘user name information’ may be displayed, and the user may designate specific ‘job identification information’ from the list. In any case, measures are taken such that the job contents (e.g., image data and attached information thereof (job content information)) may not be disclosed to users other than the user owning the corresponding job.

In a case where specific ‘job identification information’ is designated (S501, Yes), the corresponding ‘job owning user identification information’ for the designated ‘job identification information’ that is stored in the queued job management table 4b of FIG. 5 is specified (S502), and the specified ‘job owning user identification information’ is compared with the ‘authorized user identification information’ currently registered in the queued job management table 4a of FIG. 4 (S503).

If it is determined from the comparison that the ‘job owning user identification information’ and the ‘authorized user identification information’ match (S503, Yes); that is, if the user owning the queued job identified by the designated ‘job identification information’ is already authenticated, the authentication process for the user may be omitted, and the operation may move on to a queued job access execution process (S511).

On the other hand, if it is determined from the comparison that the ‘job owning user identification information’ and the ‘authorized user identification information’ do not match (S503, No); that is, when the user wishing to access the queued job corresponds to the owner of the designated queued job but does not correspond to the currently authorized user, an administrator authentication process is conducted (S505).

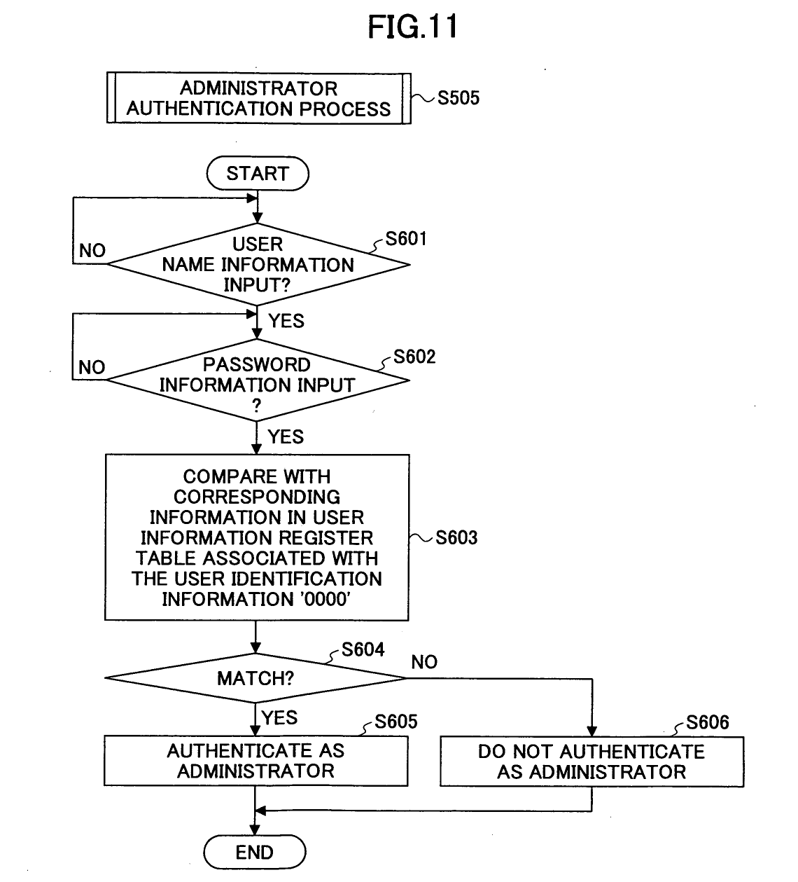

FIG. 11 is a flowchart illustrating process steps for conducting the administrator authentication process S505.

In FIG. 11, first, monitoring is conducted to determine whether user name information is input (S601). Since the administrator knows his/her ‘user name information’ and ‘password information’, first, the administrator may input his/her ‘user name information’. Specifically, the administrator may input the user name information ‘admin’ corresponding to the user identification information ‘0000’ of the user information register table 5a of FIG. 3.

After determining that ‘user name information’ has been input (S601, Yes), monitoring is conducted to determine whether password information is input (S602). For example, the administrator that is identified by the user identification information ‘0000’ may input ‘7584’ as the ‘password information’ according to the user information register table 5a of FIG. 3.

After determining that ‘password information’ has been input (S602, Yes), the ‘user name information’ input detected in step S601 and the ‘password information’ input detected in step S602 are compared with their corresponding information registered in association with the user identification information ‘0000’ in the user information register table 5a of FIG. 3 (S603). If the input ‘user name information’ and ‘password information’ correspond to (match with) the registered ‘user name information’ and ‘password information’ (S604, Yes), the user inputting the above information may be authenticated as the administrator (S605). If the input information and the registered information do not correspond (S604, No), the user is not authenticated as the administrator (S606).

Referring back to FIG. 10, after conducting the administrator authentication process S505, a determination is made as to whether the administrator has been authenticated (S506). In the case where the administrator has been authenticated (S506, Yes), the queued job access execution process S511 is conducted. In the case where the administrator is not authenticated (S506, No), an authentication error message such as that indicating, ‘You are unauthorized to use this apparatus’ or ‘An incorrect password has been input’, is displayed on the operations display unit 7, and the operation moves on to an interrupt queued job access authentication process S508.

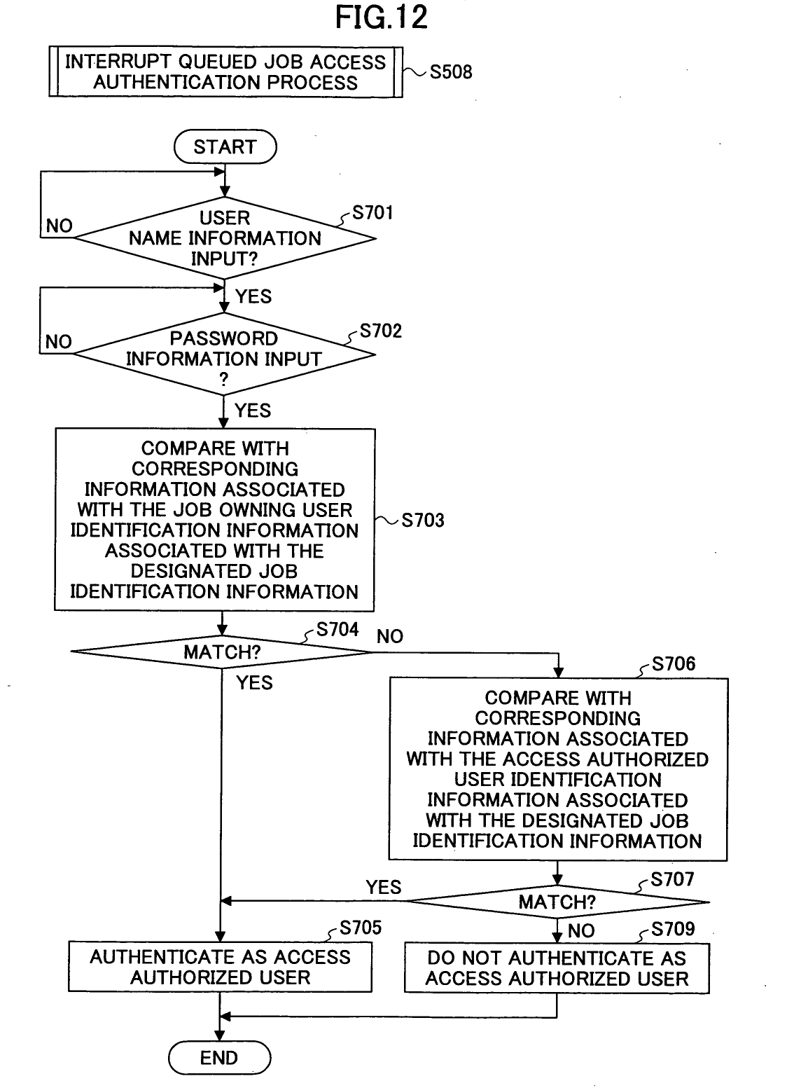

FIG. 12 is a flowchart illustrating process steps for conducting the interrupt queued job access authentication process S508.

In FIG. 12, first, monitoring is conducted for determining whether ‘user name information’ is input (S701) Since the user is informed of his/her corresponding ‘user name information’ and ‘pass word information’ by the administrator, the user may input his/her corresponding ‘user name information’. For example, if the user corresponds to a user identified by the user identification information ‘0001’, the user may input ‘kimura’ as the ‘user name information’.

After a user name information input is detected (S701, Yes), monitoring is conducted to determine whether ‘password information’ is input (S702). For example, if the user corresponds to the user identified by the user identification information ‘0001’ in the user information register table 5a of FIG. 3, the user may input ‘1234’ as the password information.

After a password information input is detected (S702, Yes), the ‘user identification information’ input detected in step S701 and the ‘password information’ input detected in step S702 are compared with corresponding ‘user name information’ and ‘password information’ in the user information register table 5a of FIG. 3 that are registered in association with the ‘job owning user identification information’ identified in step S502 corresponding to the ‘job identification information’ designated in step S501 (step S703).

In a case where it is determined that the input ‘user name information’ and ‘password information’ correspond to (match with) the ‘user name information’ and ‘password information’ registered in association with the ‘job owning user identification information’ registered in association with the designated ‘job identification information’ (S704, Yes), the user identified by the above ‘job owning user identification information’ is authenticated as an authorized user (S705). On the other hand, in a case where the input information and the registered information do not correspond (S704, No), the ‘user identification information’ input detected in step S701 and the ‘password information’ input detected in step S702 are compared with corresponding ‘user name information’ and ‘password information’ of the user information register table 5a of FIG. 3 that are associated with the ‘access authorized user identification information’ of the queued job management table 4b of FIG. 4 that is associated with the ‘job identification information’ designated in step S501 of FIG. 10 (S706).

In a case where it is determined that the input ‘user name information’ and ‘password information’ correspond to (match with) the ‘user name information’ and ‘password information’ registered in association with the ‘access authorized user identification information’ corresponding to the designated ‘job identification information’ (S707, Yes), the user identified by the above ‘access authorized user identification information’, it is authenticated as an authorized user (S705). On the other hand, in a case where the input information and the registered information do not correspond (S704, No), the user is not authenticated as an authorized user (S709). It is noted that in a further embodiment (not shown in FIG. 12), when it is determined that the input information and the registered information correspond (match) in the comparison step S706, flag values may be stored in the RAM 3 to indicate the corresponding item (access type) out of ‘referencing’, ‘changing’, and ‘canceling’ for which a match is established with the input information. In this way, the access type that the corresponding user is authorized to conduct may be indicated, and determined authorization control with respect to the respective access types may be realized.

Referring back to FIG. 10, after the interrupt queued job access authentication process S508 is conducted, a determination is made as to whether the user subject to the interrupt queued job access authentication process is authenticated (S509). If the user is authenticated as a user authorized to conduct an interrupt access operation with respect to a queued job (S509, Yes), the queued job access execution process S511 is conducted. If the user is not authenticated as a user authorized to conduct the interrupt access operation (S509, No), an authentication error message such as that indicating, ‘You are unauthorized to use this apparatus’ or ‘An incorrect password has been input’, is displayed on the operations display unit 7, and the operation is ended.

As can be appreciated from the above descriptions, according to the present example, there are three types of users that may be authorized to conduct the queued job access execution process S511. A first type of such a user corresponds to a user that owns the queued job that is designated in step S501 and is already (currently) authorized to use the multifunction printer 1. A second type of such a user corresponds to a user that is registered as the administrator of the multifunction printer 1. A third type of such a user corresponds to a user that owns or is authorized to access the queued job designated in step S501 and is authenticated through an interrupt queued job access authentication process.

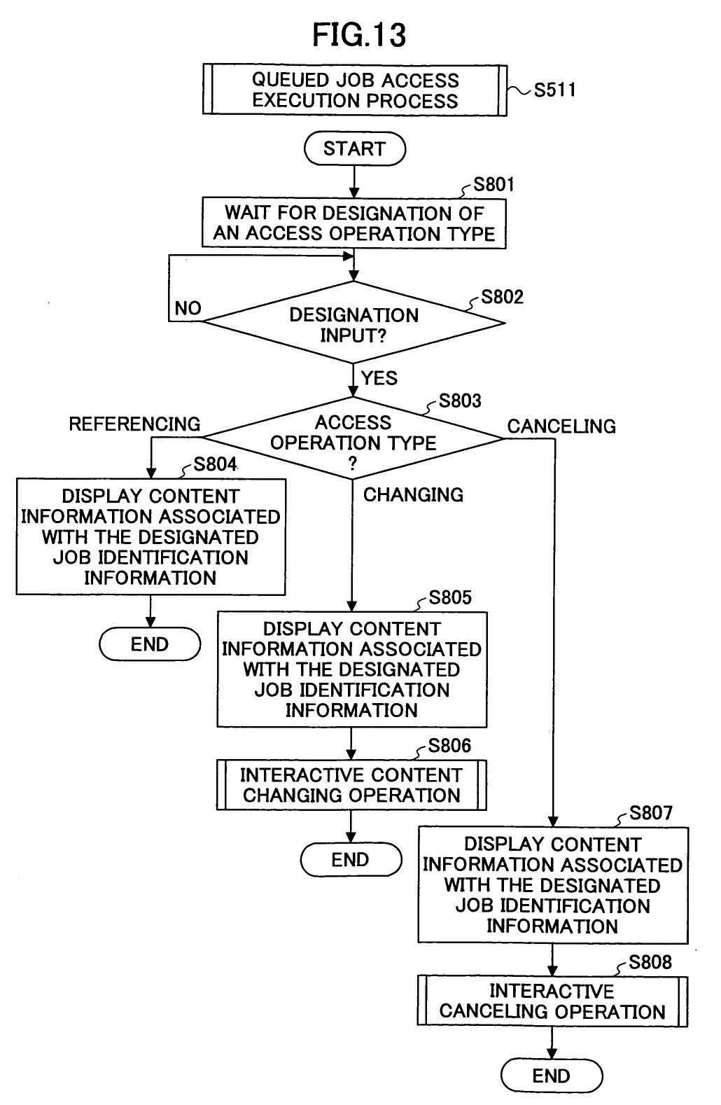

FIG. 13 is a flowchart illustrating process steps for conducting the queued job access execution process S511.

In FIG. 13, first, monitoring is conducted to detect an operation input designating any one of the access operation types, ‘referencing’, ‘changing’, or ‘canceling’, that is input via the operations input unit 7 (S801 and S802).

When it is determined that a designation input has been made (S802, Yes), the designated type of access operation is determined (S803).

If it is determined in step S803 that the designated type of access operation corresponds to ‘referencing’, content information such as the corresponding ‘job content information’ registered in the queued job management table 4b of FIG. 5 in association with the ‘job identification information’ designated in step S501 of FIG. 10 is displayed at the operations display unit 7 (S804). In one embodiment, image data identified by the ‘image data storage address’ in the queued job management table 4b may be displayed in the display part of the operations display unit 7 in order to facilitate checking or confirmation of content information.

If it is determined in step S803 that the designated type of access operation corresponds to ‘changing’, content information such as the corresponding ‘job content information’ registered in the queued job management table 4b of FIG. 5 in association with the ‘job identification information’ designated in step S501 of FIG. 10 is displayed at the operations display unit 7 (S805). In one embodiment, image data identified by the ‘image data storage address’ in the queued job management table 4b may be displayed in the display part of the operations display unit 7 in order to facilitate checking or confirmation of content information. Then, an interactive content change operation process S806 is conducted with respect to the content information displayed at the operations display unit 7. For example, the process S806 may correspond to changing the designated number of copies or the transmission destination through operation of the keys of the operations display unit 7.

If it is determined in step S803 that the designated type of access operation corresponds to ‘canceling’, content information such as the corresponding ‘job content information’ registered in the queued job management table 4b of FIG. 5 in association with the ‘job identification information’ designated in step S501 of FIG. 10 is displayed at the operations display unit 7 (S807). In one embodiment, image data identified by the ‘image data storage address’ in the queued job management table 4b may be displayed in the display part of the operations display unit 7 in order to facilitate checking or confirmation of content information. Then an interactive canceling operation process S808 is conducted with respect to the displayed content information. For example, the process S808 may involve deleting the field contents of the entry in the queued job management table 4b of FIG. 5 corresponding to the designated ‘job identification information’, and deleting from the RAM 3 the image data identified by ‘image data storage address’ that is associated with the job being subject to the canceling operation.

It is noted that in the queued job access execution process of FIG. 13, if the user conducting the queued job access execution process S511 of FIG. 10 corresponds to a user that is authenticated through the interrupt queued job access authentication process S508 (S509, Yes), and the user is further authenticated in step S707 as a user authorized to access the designated queued job; that is, if the authenticated user corresponds to a user registered in one of the items ‘referencing’, ‘changing’ or ‘canceling’ of the ‘access authorized user identification information’, the access operation type is already determined and thereby the process steps S801, S802, and S803 of FIG. 13 pertaining to the designation of the access operation type may be omitted, and the process step S804, the process steps S805 and S806, or the process steps S807 and S808 may be conducted according to the determined access operation type.

As is described above, according to an embodiment of the present invention, access operations such as ‘referencing’, ‘changing’, and/or ‘canceling’ with respect to a designated queued job may not be conducted by any user. That is, the access operations may only be conducted by certain users, such as a user owning the designated queued job that is currently authorized to use the multifunction printer 1, a user owning the designated queued job that is authenticated as a user authorized to conduct an interrupt queued job access operation with respect to the designated queued job, a user that is authenticated as the administrator, or a user that doe not own the designated queued job but is registered as an access authorized user and is authenticated as a user authorized to conduct an interrupt queued job access operation with respect to the designated queued job. In this way, the confidentiality of a queued job may be maintained while allowing (controlled) access to the queued job.

It is noted that according to the embodiments described above, a job input operation is conducted via the read unit 8 and operations display unit 7 of the multifunction printer 1, and the input operations for accessing a queued job are realized via the operations display unit 7; however, the present invention is not limited to such embodiments. For example, a job (i.e., job content information including image data and attached information thereof such as the designated number of copies and/or transmission destination) may be input to the multifunction printer 1 from the PC 101a shown in FIG. 1 connected to the LAN 100 via the LAN communication control unit 11, input operations for accessing a queued job may be conducted at the PC 101a (by an application installed in the PC 101a), and the PC 101a and the multifunction printer 1 as the image output apparatus may be arranged to exchange information via the LAN 100. In such a case, a display monitor of the PC 101a may be used as the display part of the operations display unit 7, and a keyboard of the PC 101a may be used as the keys of the operations display unit 7. As is described above, the present invention is not limited to a particular job input method or operation input method for accessing a queued job.

In the following, advantageous effects realized by embodiments of the present invention are described.

In an image output apparatus according to an embodiment of the present invention, access to a designated queued job may not be authorized unless the user requesting the access corresponds to a user that owns the designated queued job and is authenticated as an authorized apparatus user, and thereby, confidentiality of the queued job may be maintained while allowing access to the queued job.

According to an embodiment, access to a designated queued job may not be authorized unless the user requesting the access corresponds to a user that owns the designated queued job and is authenticated as an authorized apparatus user, or a user that owns the designated queued job and is authenticated as an interrupt queued job access authorized user. In this way, confidentiality of the queued job may be maintained while allowing access to the queued job. Also, in the present embodiment, a user other than the currently authorized apparatus user may be able to access his/her queued job through an interrupt queued job access process so that usability of the apparatus may be improved.

According to an embodiment, access to a designated queued job may not be authorized unless the user requesting the access corresponds to a user that owns the designated queued job and is authenticated as an authorized apparatus user, or a user that is authenticated as an administrator. In this way, confidentiality of the queued job may be maintained while allowing access to the queued job. Also, in the present embodiment, the administrator, as a user other than the currently authorized apparatus user, is able to access a queued job input by a given user through an interrupt queued job access process so that usability of the apparatus may be improved.

According to an embodiment, a user other than the user owning a queued job may be set to be authorized to access the queued job. In the present embodiemnt, a user may give authorization to certain other users to access his/her queued job so that usability of the apparatus may be improved.

According to an embodiment, access to a queued job may be authorized for a user that does not own the queued job but is authenticated as an interrupt queued job access authorized user. In the present embodiment, a user may give authorization to certain other users to access his/her queued job so that usability of the apparatus may be improved.

Further, it is noted that the present invention is not limited to the specific embodiments described above, and variations and modifications may be made without departing from the scope of the present invention.

The present application is based on and claims the benefit of the earlier filing date of Japanese Patent Application No. 2004-144374 filed on May 14, 2004, the entire contents of which are hereby incorporated by reference.

1. An image output apparatus that is configured to input image data and attached information thereof as a job, temporarily store the input job as a queued job, and output the image data of the queued job in a predetermined format when a predetermined process starting condition is satisfied, the apparatus comprising:
an authorized apparatus user authentication part that determines whether a user corresponds to an authorized apparatus user through a predetermined authentication process before the user conducts a job input operation, and upon determining that the user corresponds to the authorized apparatus user, sets user identification information associated with the user as authorized apparatus user identification information;
a queued job management part that stores a job input after authentication by the authorized apparatus user authentication part as a queued job associated with user information that is currently set as the authorized apparatus user identification information by the authorized apparatus user authentication part;
a queued job access management part that authorizes access to a designated queued job for which access is requested by a queued job access request in a case where user identification information associated with the designated queued job that is stored in the queued job management part corresponds to the user identification information currently set as the authorized apparatus user identification information by the authorized apparatus user authentication part; and
a queued job access executing part that conducts predetermined access control with respect to the designated queued job for which access is authorized by the queued job access management part.

2. The image output apparatus as claimed in claim 1, wherein
the predetermined access control conducted by the queued job access executing part includes controlling referencing of the designated queued job.

3. The image output apparatus as claimed in claim 1 wherein
the predetermined access control conducted by the queued job access executing part includes controlling changing of the attached information of the designated queued job.

4. The image output apparatus as claimed in claim 1, wherein
the predetermined access control conducted by the queued job access executing part includes controlling canceling of the designated queued job.

5. The image output apparatus as claimed in claim 1, wherein
when the user identification information associated with the designated queued job that is stored in the queued job management part does not correspond to the user identification information currently set as the authorized apparatus user identification information by the authorized apparatus user authentication part,
the queued job access management part is arranged to authorize access to the designated queued job in a case where a user identified by the user identification information associated with the designated queued job that is stored in the queued job management part is authorized to conduct an interrupt queued job access operation through a predetermined interrupt queued job access authentication process.

6. The image output apparatus as claimed in claim 1, wherein
when the user identification information associated with the designated queued job that is stored in the queued job management part does not correspond to the user identification information currently set as the authorized apparatus user identification information by the authorized apparatus user authentication part,
the queued job access management part is arranged to authorize access to the designated queued job for a user that is authenticated as an administrator through a predetermined administrator authentication process.

7. The image output apparatus as claimed in claim 1, further comprising:
a queued job access authorized user setting part that stores user identification information identifying a user authorized to access the designated queued job in association with the queued job input after authentication by the authorized apparatus user authentication part and stored in the queued job management part.

8. The image output apparatus as claimed in claim 7, wherein
when the user identification information associated with the designated queued job that is stored in the queued job management part does not correspond to the user identification information currently set as the authorized apparatus user identification information by the authorized apparatus user authentication part,
the queued job access management part is arranged to authorize access to the designated queued job in a case where a user identified by user identification information associated with the designated queued job that is stored in the queued job access authorized user setting part is authorized to access the designated queued job through a predetermined access authorized user authentication process.
